(19) United States
(12) Patent Application Publication
(10) Pub. No.: US 2006/0151759 A1
(43) Pub. Date: Jul. 13, 2006

(54) Gripping and pulling device and system apparatus

(76) Inventors: Donald Key, Alpine, CA (US); Lloyd Scott, El Cajon, CA (US)

Correspondence Address: FRANK G MORKUNAS, 7750 DAGGET ST, SUITE 203, SAN DIEGO, CA, 92111, US

(21) Appl. No.: 10/890,745

(22) Filed: Jul. 13, 2004

(51) Int. Cl. H02G 1/08

(52) U.S. Cl. 254/134.3 R

(57) ABSTRACT

A puller system with an elongate adjustable frame, a ratcheting member at the front end of the frame for lockingly pulling a ratchet line attached to the ratcheting member, a gripper attached to the ratch line at one end and to an external object by one or more noose-like self-adjusting loops which securingly grip and retain the external object, and a guide pulley with pivotable sleeve at the front of the frame adapted to guide the external object which is being extracted from an in-ground opening.

### CROSS REFERENCES TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

This present invention relates to an improvement in devices and systems designed to pull embedded cables, lines, and wires from the structures from which embedded, and more particularly to pulling such cables, fiber-optics, lines, and wires from in-ground structures and in-ground conduits.

Most businesses have electrical lines embedded in conduit or other similar above-ground and in-ground channels. Businesses involving food preparation or manufacture or distributorship have hollowed cables or flexible [or non-flexible] conduits through which powder or liquid flows. In the case of soft drinks, liquor distillers or producers, or beer bottlers, there may be several smaller lines within a larger conduit through which several varieties of the bottler's product flows.

Over time, all the lines through which powder or liquid flows require inspection, cleaning, repairing, maintenance, and/or replacement. Over time, all other embedded lines also require inspection, cleaning, repairing, maintenance, and/or replacement whether by code or good business practice. In most cases, embedded lines can cover scores if not hundreds of feet or more. The longer and wider the line, the greater the strain and wight rendering it even more difficult to pull the line out from its embedded channel or embedded conduit line. For small lines extending over small distances, it is possible, though still difficult, for a one or two-person team to manually pull out the line. Typically, the team will find the ground hole source from where the line emanates, expose the line, tie a loop around the end of the line, and pull repeatedly until the full length of the line, or at least the desired length, is exposed for inspection, cleaning, repairing, maintenance, and/or replacement.

For larger and longer lines, mechanical assistance is mandated. Typical devices for such use are available from the Greenlee company, Greenlee Textron, of 4455 Boeing Drive, in Rockford, Ill., and the HIS Business Manufacturing Company, of 1180 N. Johnson, in El Cajon, Calif. The Greenlee company is the biggest company manufacturing and suppling ‘cable pullers’ for this purpose. Each manufactures such cable-pulling machines of varying capacities and strengths depending on the purpose needed. The machines are basically the same having a motor power unit, a rotatable capstan in communication with the power unit, and a rope of varying break-strength capacities. Most are usable by one person. Each requires tying the rope to the end of the embedded cable to be pulled, setting the machine, engaging the motor and captsan, and extracting the embedded cable.

All the cable-pulling machines are well-suited for the intended purpose but, each is extremely expensive to purchase, very costly to operate and maintain, and complex to use.

The present invention is a significant improvement to the above-described prior-art machines. The present invention is relatively inexpensive and can be operated manually. The gripper of the present invention loops onto the end of the embedded cable and, in noose-like fashion, adjusts to the necessary gripping diameter of the embedded cable without need for human intervention. There is no tying as is required in the prior-art machines and devices, which, when done manually, can come undone and adversely affect the extraction process. Because of the simplified construction, maintenance and durability of the present invention is enhanced. Because of the simplified construction of the present invention, its portability and use in virtually any location without special power or environmental needs, is generally assured.

As a desired length of the embedded cable has been extracted, the pulling temporarily ceases and the operator merely loosens the noose around the end of the embedded cable and easily slides the gripper device toward the origin of extraction and begins the pulling process again. As the pull initiates, the loops of the gripper devices tighten around that portion of the embedded cable and more embedded cable is extracted. The process repeats until all, if so desired, or the pre-determined length of embedded cable is extracted.

Because the break-strength of a rope or wire being used vary and can deteriorate with age, the present invention comprises a safety line extending beyond each end of the wire being used such that, should the wire exceed its break-strength capacity and snap, the safety line limits its distance of travel and negates any possible damage and injury.

The foregoing has outlined some of the more pertinent objects of the present invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF SUMMARY OF THE INVENTION

The above-noted problems, among others, are overcome by the present invention. Briefly stated, the present invention contemplates a puller system with an elongate and adjustable frame, a ratcheting member at the front end for lockingly pulling a ratchet line attached to the ratcheting member, a gripper attached to the ratch line at one end and to an external object by one or more noose-like self-adjusting loops which securingly grip and retain the external object, and a guide pulley with pivotable sleeve at the front of the frame adapted to guide the external object which is being extracted from an in-ground opening. The sleeve is adapted to insert into the in-ground opening to maintain vertical stability of the puller system while in operation.

The foregoing has outlined the more pertinent and important features of the present invention in order that the detailed description of the invention that follows may be better understood so the present contributions to the art may be more fully appreciated. Additional features of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the present invention. It also should be realized by those skilled in the art that such equivalent constructions and methods do not depart from the spirit and scope of the inventions as set forth in the appended claims.

### BRIEF DESCRIPTION OF THE DRAWINGS

For a fuller understanding of the nature and objects of the invention, reference should be had to the following detailed description taken in conjunction with the accompanying drawings in which:

FIG. 1 is perspective view of the system apparatus.

FIG. 2 is a detailed side elevation view of the gripper device.

FIG. 3 is a close-up detail view of a second embodiment of the gripper device.

FIG. 4 is a motorized system apparatus.

### DETAILED DESCRIPTION OF THE INVENTION

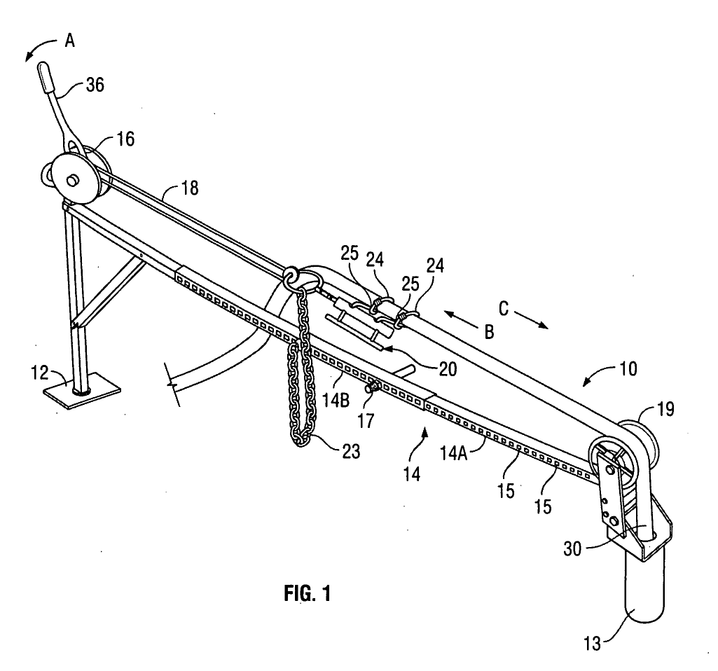

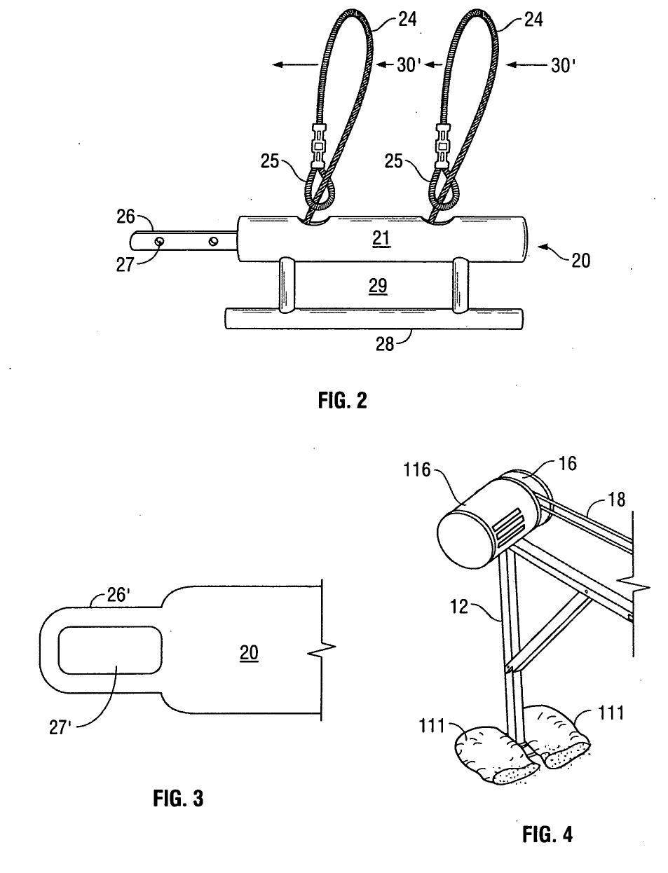

Referring now to the drawings in detail and in particular to FIG. 1, reference character 10 generally designates the complete puller apparatus system constructed in accordance with a preferred embodiment of the present invention. FIG. 2, reference character 20 designates the gripper device of the puller apparatus 10. The apparatus has a frame 14 which may be adjustable in length as needed and suited for the particular job. As illustrated, adjustability is effected by frame component 14A being slideably insertable into frame component 14B, each component 14A, 14B having matable apertures 15 into which a suitable locking member 17 may be inserted after the desired length is established for use.

At one end of the frame 14 is a conventional ratchet device 16 with handle 36 for manual operation. The pull-rating of the ratchet device 16 should be sufficient for the particular job. A pull-rating of at least 1,000 pounds up to 10,000 pounds or more is suited for most pull jobs. A typical ratchet device suited for this purpose includes, but is not limited to, a Maasdam, Pow'R-Pull, Model Number 144SB-6.

A line 18 attaches to the ratchet device 16 at one end while the other end of the line 18 is in pulling communication with the gripper device 20. Such communication may be by direct connection of the line 18 to the gripper device 20. The gripper device 20 forms an integral part of the puller apparatus 10. FIGS. 2 and 3 illustrate the detailed elements of the gripper device 20.

The gripper device 20 has a body 21 and a handle 28 connected to the body 21. An open space 29 is defined between the body 21 and the handle 28. One or more loops 24 are on the body 21 of the gripper device 20. Each loop 24 may be comprised of a flexible cord-like or rope-like material; such as, but not limited to, strand cable, twisted cable, wire, wire rope, or rope natural or synthetic, and the like; each of which is conventionally available. The break-strength of the material used to form the loop 24 should exceed the pulling force necessary for the particular job. A material bearing a break-strength of between approximately 1,000 pounds to approximately 20,000 pounds, or more, should suffice in most cases.

For reference purposes herein, and not by means of limitation, the loop 24 material shall be referred to as wire cable. One end of the wire cable is affixed to the body 21 of the gripper device 20. The other end of the wire cable has an eyelet 25 which encircles the wire cable. The encirclement of the wire cable by the eyelet is what defines the loop 24 configuration which is integral to the functionality of the gripper device 20. At one end of the body 21 is a receiver component 26 with one or more apertures therein 27 for attachment to and for receiving the line 18 as described above. For reference purposes only, and not by means of limitation, the end at which the receiver component 26 is connected is the back end.

Another embodiment of the receiver component is illustrated in FIG. 3. Here the back end and an loop-like extension 26′ defining a looped aperture 27′ therein adapted to accept and receive the ratchet line 18.

The puller apparatus 10 is designed for pulling wires or cables 30 or combinations thereof, generally from in-ground placements or in-ground conduits. For reference purposes only, not by means of limitation, these wires and cables and combinations thereof, will be referred to herein as cables. These cables can have extremely large diameters, be extremely long and well-imbedded in their respective conduit and, as a result, are very difficult to grasp, hold, and pull. Once the cable 30 is exposed and a portion extracted from its in-ground source, the loops 24 of the gripper device 20 are inserted over the cable 30. Reference character 30′ of FIG. 2 illustrates the insertion of the cable 30 by the directional arrows passing through the two loops 24.

When an operator initiates pulling action on the ratchet member 16 by moving the ratchet handle 36 generally in the direction of arrow A, the gripper device 20 moves in the direction of arrow B. The weight and resistance of the cable 30 causes the loops 24 to move in the opposite direction of arrow B, bear down on the cable 30, and self-adjust to the diameter or less of the cable 30 as the eyelets 25 move in a noose-like fashion tighter and tighter around the cable 30. This noose-like tightening is automatic with the pulling force being exerted and creates a vise-like grip around the cable 30. The power and leverage of the ratchet member 16, as it is operated, causes the cable 30 to be extracted from its in-ground source with minimal exertion on the part of the operator.

At the front end of the frame 14 is a pulley component 19 over which the cable 30 is placed. This facilitates the removal of the cable 30 from its in-ground source and further minimizes the strain on the ratchet member 16 and the operator. After a sufficient length of cable 30 is extracted or up to the point when the gripper device 20 nears the ratchet member 16 or as the ratchet member 16 has pulled all it can pull at that moment, continued pulling ceases. The ratchet member 16 is locked in place or released as necessary to relieve tension on the cable 30 and the lines in communication with the gripper device 20.

The eyelets 25 are likewise relieved of the tension and may be moved to increase the diameter of the loop 24 to permit the cable 30 to be hand-pulled through the loops 24. Once the loops 24 no longer tightly grip the cable 30, the ratchet member 16 is unlocked thereby permitting the operator to move the gripper device 20, and its attached lines, forward, in the direction of arrow C. Once forward as far as necessary, the pulling process re-commences as described above and more cable 30 is extracted from its in-ground source. Once the cable 30 is extracted as far as the pulling apparatus 10 will permit, the pulling process stops, the gripper device 20 is re-positioned as described above and so on. These processes repeat as long as necessary until the desired length of cable 30 has been extracted from its in-ground source.

To facilitate extraction and stabilization of the pulling apparatus 10, the front end of the pulling apparatus 10 has a pivotable sleeve 13. Preferably the sleeve 13 is aligned with the in-ground opening after the cable 30 has been exposed and may be placed over the in-ground or, depending on respective widths or diameters, into the in-ground opening. The front, as well as the back of the pulling apparatus also have one or more stands 12 to support the frame 14, though one at the rear with the sleeve 13 at the front is sufficient for support purposes.

In some cases the force of the pull may cause the back end of the pulling apparatus 10 to rise off the ground or the front end to be vertically unstable or unsteady. To prevent this occurrence or minimize its impact, the back end may be weighted down by any suitable weight device. As illustrated in FIG. 4, weighted sand bags 111 are applied to the stand 12 at the rear of the system apparatus 10. Any number of such weight devices, not limited to sand bags, suited for the intended purpose may be used.

Alignment of the sleeve 13 into the in-ground opening, rather than over and around the in-ground opening, is best for maintaining vertical stability. Therefore, the diameter, or width across the sleeve 13 if not round-like, should be less than the diameter or width across the in-ground opening into which the sleeve 13 is being inserted.

Another feature of the pulling apparatus 10 is a unique safety feature incorporated therein which consists of a safety line or safety chain 23, or the like, attached to the ratchet line 18 and to the frame 14. The break-strength of the safety chain 23 may, but need not, exceed the break-strength of the ratchet line 18 and the break-strength of the wire cable forming the loop 24 and eyelet 25. The safety line 23 may consist of any conventional chain, chain links, strand cable, twisted cable, wire, wire-rope, and rope. A rope may be comprised of synthetic or natural fibers; i.e., sisal, agave fiber, manila, hemp, polypropylene, nylon, polyester, or specialty fibers, or any combinations thereof.

The function of the safety line 23 is to prevent any back-snap of a broken ratchet line 18 from reaching and/or striking the user. The function is not to take the force of the pull head-on. As a result, the material used for the safety line 23 should have a safety rating of at least 100 pounds and up.

As illustrated in FIG. 4, the ratchet member 16 may be connected to any conventional electronic motor 116 suited for the intended purpose. Use of an automated means for turning the ratchet member 16 eases the work load and strain for the operator and, with sufficient horsepower, will extract the cable 30 faster. A typical motor for this purpose may be a Dayton Electric Winch, Model Number 5W659, though any similar motor or device suited for the intended purpose may be used.

The present disclosure includes that contained in the present claims as well as that of the foregoing description. Although this invention has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the invention. Accordingly, the scope of the invention should be determined not by the embodiments illustrated, but by the appended claims and their legal equivalents.

The invention claimed is:

1. A gripper device comprising:
(a) a body;
(b) a handle attached to said body; and
(c) one or more loops on said body adapted to grasp and grip an external object inserted into said on or more loops;
whereby when said external object is inserted into said one or more loops and said gripper device is moved in a direction away from said external object, said one or more loops bear down on said external object thereby holding said external object in place.

2. The device of claim 1 wherein said one or more loops are flexible.

3. The device of claim 2 wherein said one or more loops are comprised of a material selected from the group consisting of strand cable, twisted cable, wire, wire rope, and rope.

4. The device of claim 1 further comprising adjustment means on said one or more loops.

5. The device of claim 4 wherein said adjustment means comprises an eyelet at one end of said one or more loops wherein said eyelet is slidingly wrapped around said loop.

6. The device of claim 1 further comprising receiver means at one end of said body for receiving an external line wherein said external line is adapted to exert force on said gripper device in a direction away said external object.

7. The device of claim 6 wherein said receiver means comprises an extending tongue having one or more apertures therein.

8. The device of claim 6 wherein said receiver means comprises a looped extension.

9. A puller system comprising:
(a) an elongate frame having a first end and a second end;
(b) ratcheting means at said first end for lockingly pulling a line attached to said ratcheting means toward said first end;
(c) a guide pulley adjacent to said second end and adapted to guide an external object being extracted from an in-ground opening; and
(d) a gripper member connectable to said line, said gripper member adapted to securingly grip and retain said external object.

10. The puller system of claim 9 wherein said ratcheting means further comprises an engagable and disengagable electronic motor.

11. The puller system of claim 9 wherein said gripper member further comprises a body; a handle attached to said body; and one or more loops on said body adapted to grasp and grip an external object inserted into said one or more loops;
whereby when said external object is inserted into said one or more loops and said gripper member is moved in a direction away from said external object, said one or more loops bear down on said external object thereby holding said external object in place.

12. The puller system of claim 11 wherein said one or more loops are flexible.

13. The puller system of claim 12 wherein said one or more loops are comprised of a material selected from the group consisting of strand cable, twisted cable, wire, wire rope, and rope.

14. The puller system of claim 11 further comprising adjustment means on said one or more loops.

15. The puller system of claim 14 wherein said adjustment means comprises an eyelet said eyelet is slidingly wrapped around said loop.

16. The puller system of claim 11 further comprising receiver means at one end of said body for receiving said line of said ratcheting means.

17. The puller system of claim 16 wherein said receiver means comprises an extending tongue having one or more apertures therein.

18. The puller system of claim 16 wherein said receiver means comprises looped extension.

19. The puller system of claim 9 further comprising a safety line having a first end and a second and connected to said line at said first end and connected to said elongate frame at said second end at a location distal of said ratcheting means.

20. The puller system of claim 19 wherein said safety line is comprised of a material selected from the group consisting of chains, strand cable, twisted cable, wire, wire-rope, and rope.

21. The puller system of claim 9 further comprising a sleeve at said second end adapted to seat over or into said external in-ground opening.

22. The puller system of claim 9 further comprising a stabilizing means for stabilizing said puller system while in operation.

23. The puller system of claim 22 wherein said stabilizing means comprises one or more weight devices applied to a stand upon which said elongate frame seats.
